(19) United States
(12) Patent Application Publication
(10) Pub. No.: US 2013/0212194 A1
(43) Pub. Date: Aug. 15, 2013

(54) COMMUNICATION SYSTEM AND METHOD

(71) Applicants: David Shaw, Melbourne (AU); Dmitri Shugaev, Melbourne (AU)

(72) Inventors: David Shaw, Melbourne (AU); Dmitri Shugaev, Melbourne (AU)

(73) Assignee: AUSTRALIAN POSTAL CORPORATION, Melbourne (AU)

(21) Appl. No.: 13/701,241

(22) PCT Filed: Apr. 15, 2011
(86) PCT No.: PCT/AU2011/000450

§ 371 Date: Feb. 6, 2013

(30) Foreign Application Priority Data
Apr. 15, 2010 (AU) 2010901599

(51) Int. Cl. H04L 12/24

(52) U.S. Cl. CPC H04L 41/026
USPC 709/206

(57) ABSTRACT

The present invention relates to a communication system (10) that allows members (14) to receive a wide variety of digital information and documents from senders (12). The system is comprised of a communication server (16) having: a member registration facility (20), configured to enable registration of individuals as members within the communication system; a sender registration facility (18) configured to enable registration of organisations as senders within the communication system; a SAM code generator (32), configured to generate a SAM code in response to a request from a sender to connect with a member and to forward the SAM code to the sender; and a communication facility (64) adapted to receive digital communication items including the SAM code and to direct digital communication items to members; and an address database (68) operatively coupled to the communication server, for storing the generated SAM codes.

### FIELD OF THE INVENTION

The invention relates to communications. More particularly, the present invention relates to a communication system and method for facilitating secure digital communication between senders and members.

### BACKGROUND OF THE INVENTION

Any reference to or discussion of any document, act or item of knowledge in this specification is included solely for the purpose of providing a context for the present invention. It is not suggested or represented that any of these matters or any combination thereof formed at the priority date part of the common general knowledge, or was known to be relevant to an attempt to solve any problem with which this specification is concerned.

Communication systems that enable users to securely receive electronic information from a number of separate senders are known. Internet banking services are a familiar example, enabling users to electronically receive both banking-related documents, as well as invoices from various service providers.

Another example is the ‘electronic mailbox’ services provided to citizens since about 2000 by the national Postal authorities of counties including Denmark, Canada and Norway. Such services provide each user with a secure electronic mailbox into which users receive and store documents that are otherwise sent through the postal system. Users of these services receive correspondence from government authorities, banks, pension, insurance, energy and telecommunications companies. Users can also save important private documents, such as their birth and marriage certificate, in their electronic mailbox.

However, despite such systems being available for some time, senders have tended not to adopt them in their communications with users. Consequently, users are left to establish a separate communication service with each sender from whom they wish to communicate. The present invention aims to overcome this difficulty and provide a communication system that is convenient for both senders and users.

### SUMMARY OF THE INVENTION

In its broad form, the present invention provides a communication system that allows members to receive digital information and documents from senders, and/or a method of facilitating digital communications between senders and members.

According to an aspect of the present invention there is provided a communication system for facilitating digital communications between senders and members, said system comprising:
a communication server having or associated with:
   a member registration facility, configured to enable registration of individuals as members within the communication system;
   a sender registration facility, configured to enable registration of organisations as senders within the communication system;
   a SAM code generator, configured to generate a SAM code in response to a request from a sender to connect with a member and to forward the SAM code to the sender; and
   a communication facility adapted to receive digital communication items including the SAM code and to direct digital communication items to members; and
a database operatively coupled to the communication server, for storing the generated SAM codes.

A SAM code, taken from an abbreviation of ‘Sender's Address to the Member’ is a code that is generated by the communication server to signify that a member has successfully set up a “connection” with a sender. Communication systems according to the invention generate a code for each such connection between senders and receivers, rather than seeking to identify senders and receivers themselves. A single, unique SAM code (of which members need not be aware) thus enables identification with the system of both parties to the connection, namely a sending and a receiving party. The SAM code may take any appropriate form, but its function is always the same, to represent the approved connection between a sender and a member, so to signify to the system that digital communication items sent by the sender can indeed be provided to the member.

It will be understood with respect to this and other aspects of the invention that the digital communication item sent on to a member (upon successful verification) may be in a substantially different form from the item received from the sender. It may be formatted or reformatted from the received data, further data may be added to the data as required, and it may be stripped of the SAM code, as this information is not required by the member, and indeed, for security of the overall system, it is preferable that the member not have access to the SAM code.

The present invention provides a secure, robust and scalable communication architecture, through which members can receive digital information from a number of different sources.

Generating a code for connections rather than seeking to identify the parties to that connection has the advantage of allowing members to have a different identity with each connected sender, or even (in some cases), multiple identifications with respect to a single sender. Members have another, separate identity, with the communication system itself.

Preferably, the SAM code generator is configured to generate a SAM code in response to a request from a sender to connect with a member, the sender having verified the member's identity before requesting a SAM code from the communication server.

According to this embodiment, senders undertake their own identity-verification procedures for prospective members before requesting the communication server to generate a SAM code for that (now identified) member. Identity-verification procedures vary from sender to sender and may occur online (such as directly through a sender's website), or offline (such as over the telephone or via an in-person interview).

For senders, this embodiment of the present invention offers a universal, auditable and secure electronic messaging platform. The invention reduces the risk of digital communications by providing a level of identity verification appropriate to each organisation's requirements. At the same time, it improves the way that organisations communicate with their customers by increasing reach, trust, timeliness and relevance of communications.

Issuance of a SAM code by the communication server responsive to a sender request, the sender having pre-verified the member's identity, signifies a successful verification within the communication system of a member's identity with that particular sender.

According to preferred embodiments, the communication system further includes an address database for storing the SAM codes.

Typically, the sender registration facility is further configured to issue a unique sender address to organisations upon registration thereof as senders within the communication system, the sender address being included in the sender's digital communication items. According to preferred embodiments, the communication system further includes a database of sender records for storing the unique sender addresses.

Optimally, the communication server includes a connection management module configured to receive requests from members concerning members' connections to senders. Typically, the connection management module is adapted to receive requests from members to delete the connection to a selected sender, whereupon the SAM code allocated to the selected sender is deleted from the address database.

Preferably, the communication facility is adapted to execute a message authentication or verification process upon receipt of communication items at the communication server. Typically, the message authentication or verification process comprises:
determining whether the sender address of the received communication item is present in the database of sender records; and
determining whether the SAM code in the received communication item is present in the SAM code database.

According to particularly preferred embodiments of the present invention, the communication system further includes a secure storage database for secure storage and selective retrieval of members' communication items. Individuals can thus securely store important documents in the secure storage database knowing they are accessible to them at anytime.

According to a further aspect of the present invention there is provided a method of facilitating digital communications between senders and members, said method comprising the steps of:
providing a communication system according to the first aspect of the invention;
receiving and processing requests from organisations and individuals for registration with the communication system;
receiving digital communication items including SAM codes; and
directing digital communication items to members.

According to a further aspect of the present invention there is provided a method of facilitating digital communication between senders and members, said method comprising the steps of:
providing a communication server having:
a user interface through which individuals can register as members in the communication system; and
a sender interface through which senders can register as senders in the communication system;
receiving a request from a member to connect with a sender;
communicating the request to the sender, whereupon the sender performs an identity verification on the member;
receiving a request for a SAM code from the sender;
generating a SAM code and providing the SAM code to the sender;
storing the SAM code in a database; and
upon receipt of a digital communication item from a sender including a SAM code, determining whether the SAM code is present in the database.

The method preferably includes the step of, if the SAM code is present in the database, sending the digital communication item to the member.

As discussed above, the SAM code provides a confirmation of successful identification verification of the member by the sender.

The present invention provides a range of secure electronic services to be delivered to individuals and accessible from any web-enabled device such as a computer or mobile phone.

In addition, the invention allow individuals to securely receive and process documents (for example statements, invoices and promotional materials) from a range of government and commercial enterprises. It allows individuals to control the way that they receive documents, either via physical mail or digital communication. Communication items sent within the communication system may also be actionable items, thus enabling bills to be paid, forms returned and calendar appointments made.

The present invention offers individuals different ways of securely managing official communications and transactions with sender organisations. Preferred embodiments provide personal and household management tools such as calendars and personal finance components.

### BRIEF DESCRIPTION OF THE DRAWINGS

The invention will now be further explained and illustrated by reference to the accompanying drawings in which:

FIG. 1 is a block diagram of a communication system in accordance with an embodiment of the present invention;

FIG. 2 is a block diagram illustrating the software modules used to implement the communication system illustrated in FIG. 1;

FIGS. 3 and 4 are block diagrams of the sub-modules making up the member application module illustrated in FIG. 2;

FIG. 5 is a flow chart illustrating the process of establishing a connection between a member and a sender within the communication system illustrated in FIG. 1;

FIGS. 6 and 7 are schematic illustrations of a member account record stored in the member database illustrated in FIG. 1;

FIG. 8 is a schematic illustration of the step of performing an online authentication of a members identity;

FIGS. 9 and 10 are schematic illustrations of the step of performing an offline authentication of a member's identity;

FIG. 11 is a block diagram illustrating the sending of communication items from a plurality of senders to a member, within the communication system illustrated in FIG. 1;

FIG. 12 is a schematic illustration of the database of unique delivery addresses illustrated in FIG. 1;

FIG. 13 is a flow chart illustrating the process of verification of communication items received at the delivery server illustrated in FIG. 1;

FIG. 14 is a block diagram of the sub-modules making up the provider portal module illustrated in FIGS. 1 and 2;

FIG. 15 is a block diagram of the sub-modules making up the secure messaging module illustrated in FIG. 2;

FIGS. 16 and 17 are block diagrams illustrating the messaging interfaces that implement the messaging module routines illustrated in FIG. 15; and

FIG. 18 is a block diagram of the sub-modules making up the business support module illustrated in 2.

### DETAILED DESCRIPTION OF THE DRAWINGS

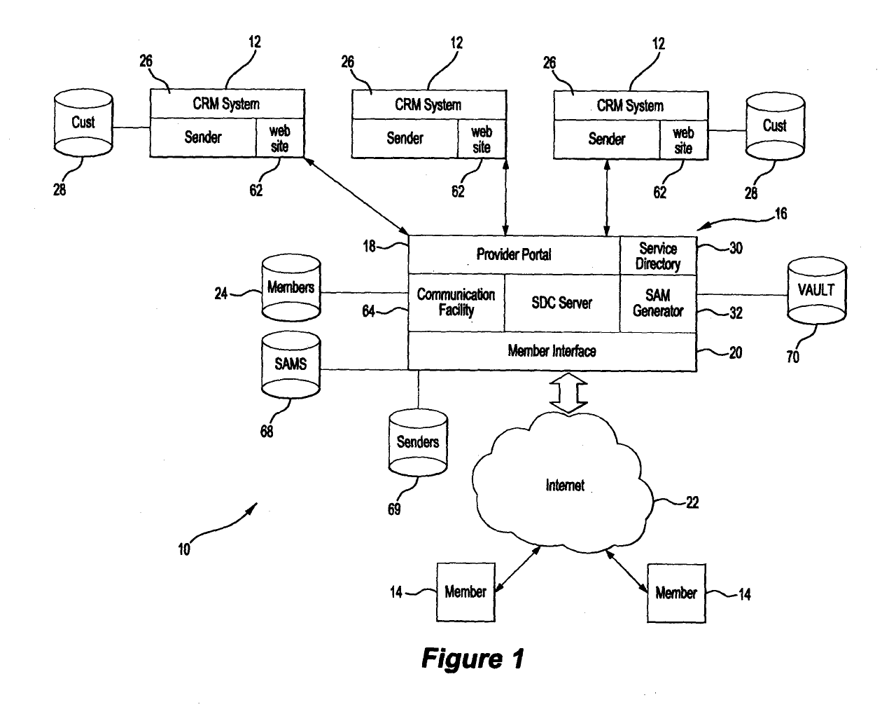

Turning to FIG. 1, a communication system 10 is illustrated. Communication system 10 is configured to facilitate the secure delivery of communication items from senders 12 to members 14. Responsibility for communication item delivery rests with a Secure Digital Communications (SDC) Server 16 that receives items from senders 12 and forwards them on to members.

Both senders 12 and members 14 register with communication system 10 via a provider portal 18 and member interface 20 respectively. Senders access member interface 20 over an access channel 22, and register with communication system 10 in a suitable manner. Access channel 22 provides multi-level access to SDC Server through the Internet (mobile or fixed) or conventional (mobile or fixed) telephone network. In the scenario of an Internet access, registration is effected by individuals completing a familiar web-based application form. The process of member registration is described in greater detail below. Once registered, information about members is stored in a member database 24.

Typically, members 14 are individual persons and senders 12 are private and public sector organisations who wish to provide communication offerings to those individuals. Organisations such as financial institutions, utility providers, telecommunications providers and government departments are typical senders 12 within communication system 10. Senders 12 deploy Customer Relationship Management (CRM) Systems 26 to keep records of their own clients and customers, details of which are stored in customer databases 28.

It will be appreciated that, in an embodiment of the invention, a member may be an organisation registered to receive digital communications from senders by way of the system.

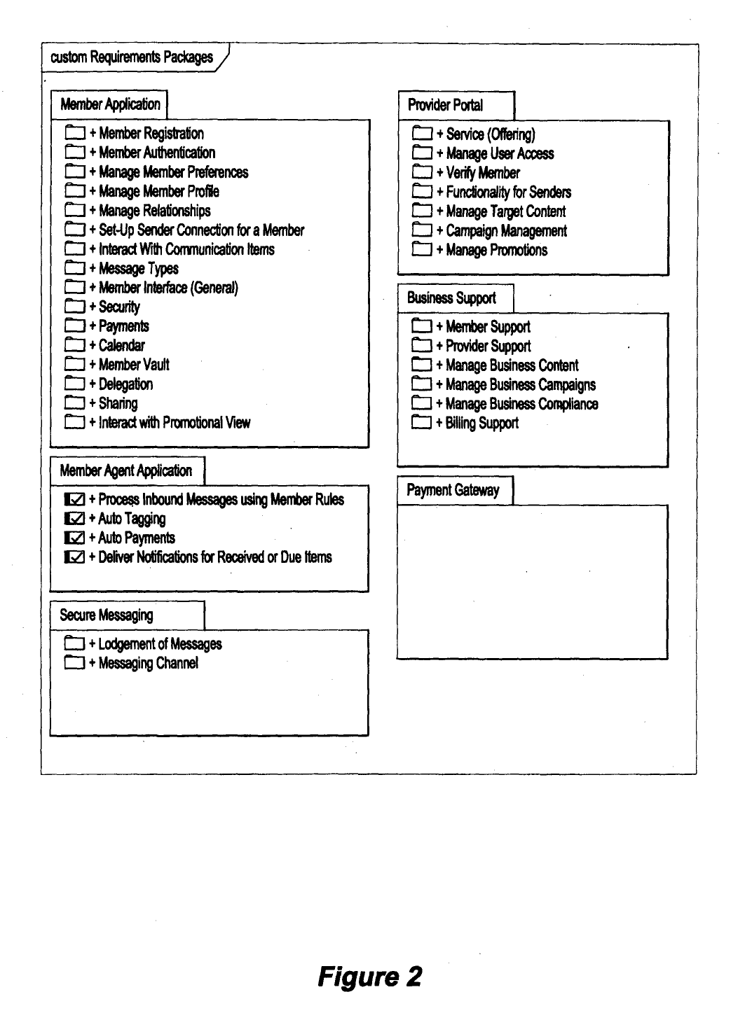

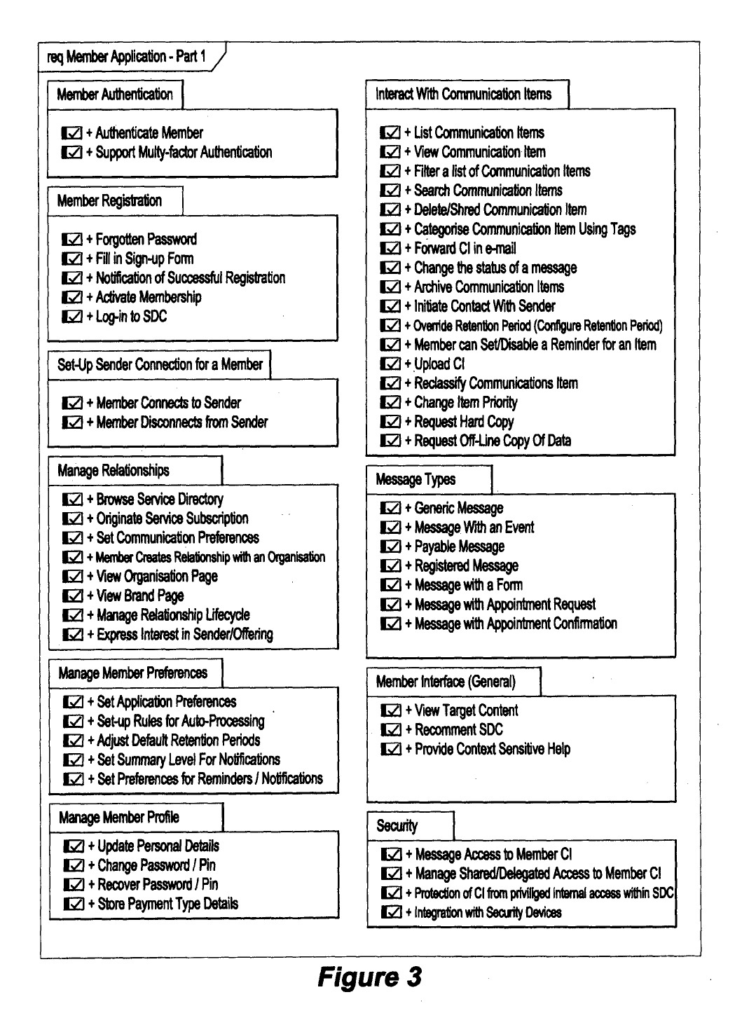

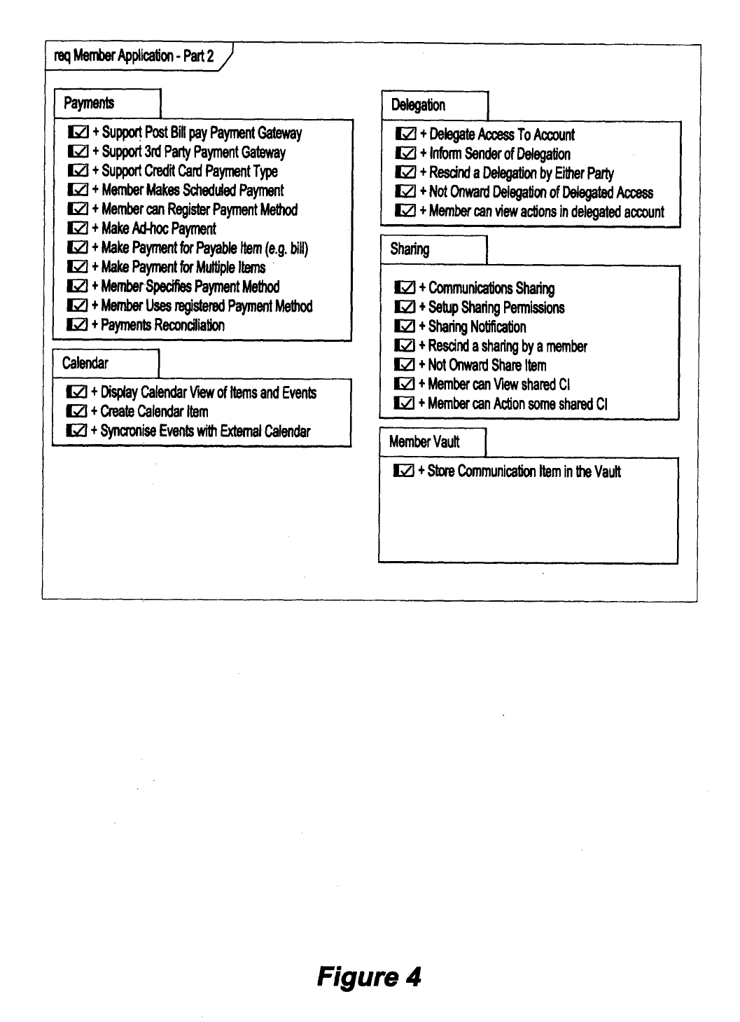

Other modules within SDC Server 16 are illustrated in FIG. 2. The Member Application Module is illustrated in FIGS. 3 and 4.

Returning to FIG. 1, and as discussed above, individuals register with communication system 10 through member interface 20 to become members. A typical such user registration process is as follows:
1. Individual visits SDC website
2. Individual clicks on a sign-up link or button displayed at website.
3. A sign-up form is displayed which the individual completes and submits.
The sign-up form solicits collection of the following information items, some of which are optional:
   Title (optional);
   First name, Last name, Email address (all compulsory);
   Username;
   Password (Password must be at least 8 characters and confirmed);
   A checkbox, indicating reading and acceptance of terms and conditions of use of communications system 10 (which are available as a link); and
   A Register button (which is exposed only after the terms and conditions checkbox has been clicked)
4. A Registration-successful page is displayed with instructional text about the next steps in the process.
5. SDC Server 16 sends a registration email to the individual that includes a URL and instructions directing copying and pasting of the URL into a web browser.
6. Individual copies and pastes URL into a web browser.
7. A Registration-complete page is displayed confirming the individual as a registered member.
8. Member is able to log-in to SDC Server 16 using the username and password supplied during sign-up.
9. Member is able to reset their password and/or security token if forgotten.

As discussed above, to login to SDC Server, a Member needs to enter username and password. This is the minimal (mandatory) level of member authentication. Support for multi-factor authentication for members, such as ‘Verisign VIP token’, is also provided.

The Manage Member Preferences module (FIG. 3) enables members to manage information in their profile. Member can set and change their preferences which will modify behaviour of the interface and treatment of member communications or transactions.

For example, members can choose to store their action outcomes in the system, which can consequently be used by communication system as repetitive rules for future similar actions against similar messages. For example, when members are making a payment for a utility bill they can also set up rules to pay any future bills from that company within a threshold.

Similarly, members can adjust the standard retention period for a specific communication item. They can also choose whether to apply the rule to all future communication items of this type. The adjustment will be limited by a maximum set by the Retention Policy.

Based on a preference selection, an individual member's reminder notifications will be aggregated at a summary level to be received at a particular regular interval and time. EG: Send me an SMS when I have more than 5 unread messages in my inbox.

Members can also set rules which will govern creation and delivery of reminders/notifications.

The Manage Member Profile sub-module includes routines to give registered members the ability to manage their profile. Member profiles represents a logical grouping of personal attributes of the member. All attributes of this functionality is maintained by the registered member.

Member profiles also include a holistic view of a member's communications with provider organisations in accordance with their preferences. Users can update their personal details stored in their profiles; change their password or pin; recover lost password/pin; and store payment type details.

Once organisations and individuals are registered with communications system 10, members 14 establish and manage relationships and connections with senders 12. Senders 12 provide details of their communication service offerings in a service directory 30 (FIG. 1), from which members 14 can view a list of brands/services available via SDC Server 16 and discover details of available communications offerings to which they can subscribe.

Service directory includes details of:
Organisations (not registered; consequently details are entered by SDC business support). Members 14 can create relationships with organisations. Organisations become Providers by registering their services/offerings in service directory 30.
Providers (registered; can access provider portal 18 and create services). Member can subscribe to services. Providers become Senders once the first Member has made a connection to them.
Senders (registered; can access provider portal 18, create services and send messages). Member can connect and receive messages.

Originate Service Subscription

Members 14 can subscribe to service offerings found in service directory 30. The subscription process is initiated by selecting the offering, while the completion of subscription will depend on the type of service offering and performance of appropriate workflows. For example, if a subscription requires an identity verification, the workflow typically includes an in-person or other interaction with the sender/provider organisation before the subscription is active.

Set Communication Preferences

Members 14 express their preference for receiving communications from a particular organisation over a particular channel (the fulfilment of those preferences depending on the current capabilities of the sender/provider organisation).

Relationship Creation

SDC server 16 enables members 14 to organize, view and react to information based in a relationship context. Setting-up a Relationship with an Organisation in SDC communication system 10, allows Members to view an Organisation page and view or edit information available on that page.

Relationships may exist in the absence of a member connection or subscription to any services. However, the Organisation must be part of the service directory to be a party to a relationship. Conversely, a relationship is always created when members 14 have connected to senders 12 or subscribed to Providers' services.

View Organisation Page

Members can access a holistic view of their communications organised around sender/provider organisations brands (brand-centric experience). Organisation pages are created only for senders 12 to which members 14 have connected. Unconnected senders can, however, display a Brand Page (see below).

View List of Connections

Members can view list of established connections with Sender Organisations.

View Brand Page

Members can view a Sender brand page for each Sender in service directory 30 to which they are not connected. A brand page is not a page on an organisations' web site, but a page within SDC server 30 on which a registered sender can manage their content.

Manage Relationship Lifecycle

Members can manage all stages of a Relationship including:
expression of an interest;
initial subscription/connection;
monitoring ongoing subscription; and
final un-subscription/disconnection.

Express Interest in Sender/Offering

Members 14 can indicate their interest in receiving SDC communications from a particular service/offering which may not exist in SDC or with whom member has not subscribed.

Establishing Sender Connections

A Sender Connection can be seen as both a process and an outcome of connecting members 14 with senders 12 for the purpose of receiving digital communications and/or subscribing to a broader range of services. A fundamental aspect of a connection between member 14 and sender 12 is a SAM code (an acronym from ‘Sender's Address to the Member’), referred to below as a “SAM” which is a tag included in communications and, in more general sense, signifies a member's 14 relationship to sender 12, set up by successful verification of the member's identity by the sender.

Each connection between member and sender 12 includes a number of sender offerings, which provide a more granular way of managing and controlling types or categories of communications (transactional, promotional, etc.) and other services offered by the Organisation.

SAMs are generated by address generator 32.

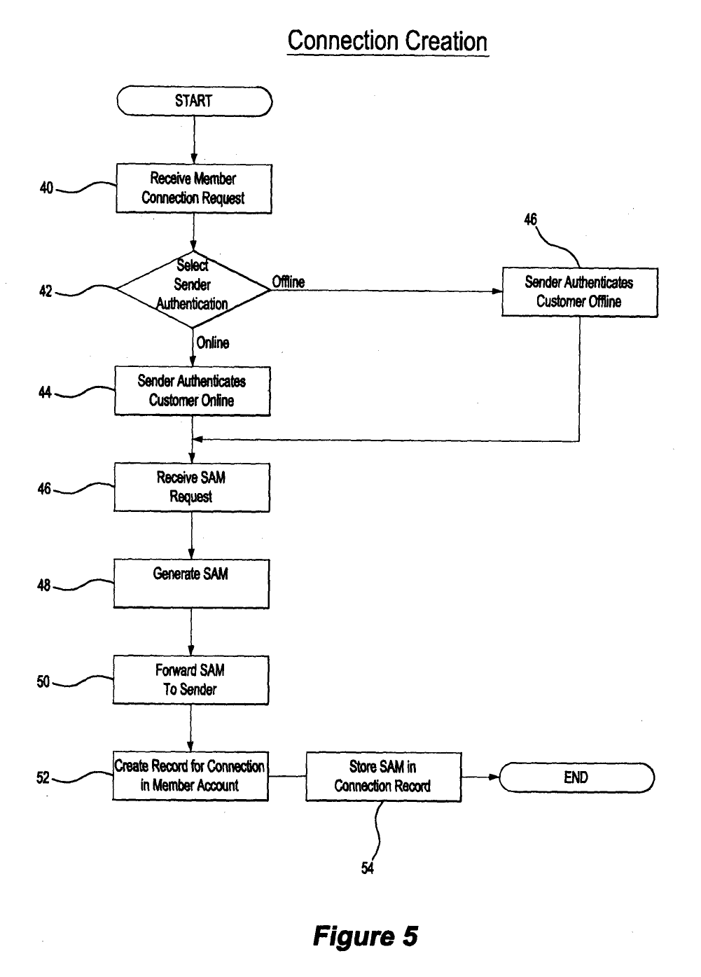

The process by which communication system 10 creates a connection between a member 14 and a sender 12 is described in the flow chart of FIG. 5. At step 40 member 16 indicates a desire to connect to sender 12 by accessing member interface 20. The connection request is thus received at SDC Server 16.

For a connection to be established within communication system 10, member 14's identity must be established to the satisfaction of sender 12. To this end, at step 42, SDC Server 16 redirects the connection request to sender 12 to enable sender to authenticate member 14's identity. If sender 14 can perform an identity authentication online, such as through sender 14's web site or CRM System 26, the connection process (step 44) is redirected to an online authenticator.

Alternatively, if online authentication is not feasible, the connection process (step 44) is redirected to an offline authenticator, such as a call centre for identity authentication over the phone, or a physical office, for an in-person authentication.

In the event of a successful authentication by sender 12 of member 14's identity, sender (step 46) requests SDC server 16 to issue a SAM code for member 14, to be included in future communications to and from member 14, and (in a more general sense) signify a connection between member 14 and sender 12.

At step 48, SAM generator 32 generates a SAM in response to the SAM request, and forwards (at step 50) the generated SAM to sender 14.

At step 52, SDC Server 16 enters details of the established connection in user 12's record in member database 24.

At step 54, SDC Server 16 records the generated SAM in user 12's record in member database 24 in association with the established connection.

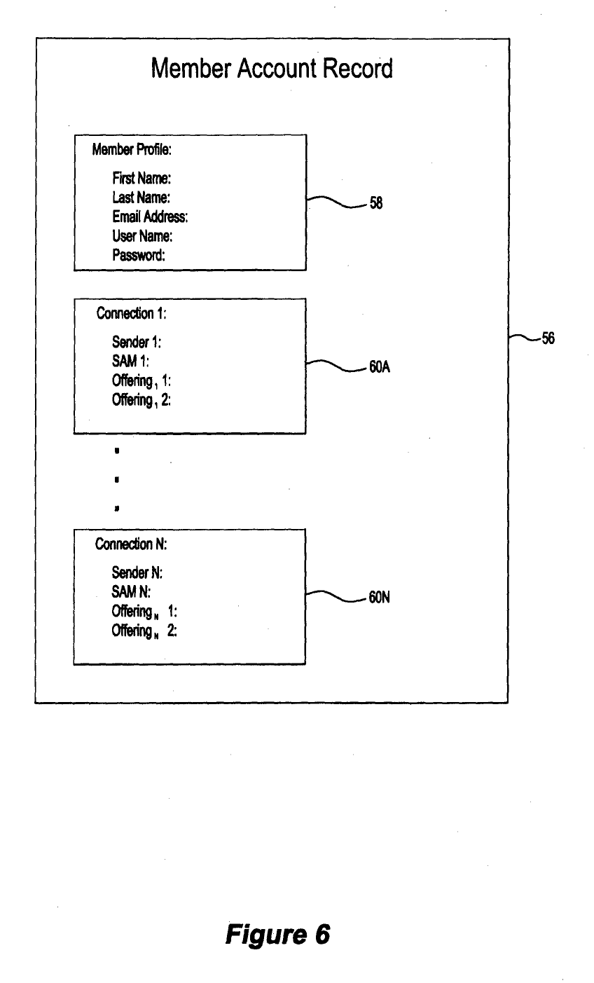

An example of a member record 56 in member database 24 after member 14 has established connections with several senders 12 is illustrated in FIG. 6. Record 56 has a profile field 58, that records the bibliographic information collected from member 14 during the registration process described above.

Connection fields 60A-60N exist for each connection established by member 14 to a sender 12. Each connection field 60 records:
Name of sender;
SAM generated for that connection; and
Particular sender offerings

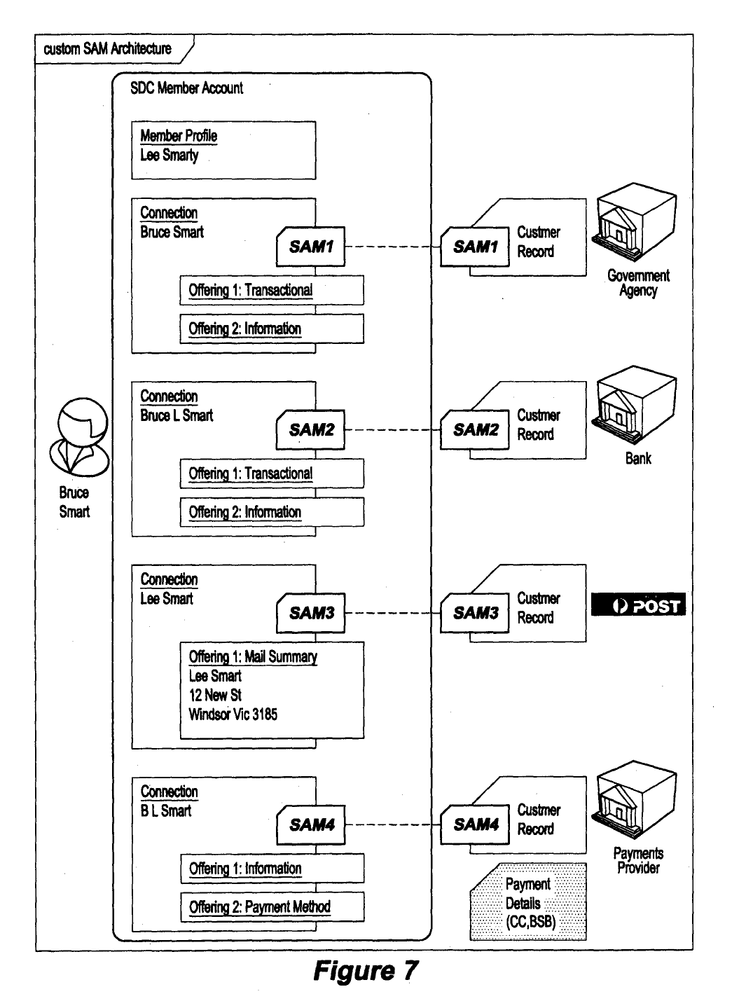

FIG. 7 is another illustration of the SAM scheme and the functioning of that scheme with a plurality of senders. The example is of a complex identity situation, involving possible deviations of identity information between senders.

In this example a person named Bruce L. Smart is a registered member with communication system 10. He has registered as Lee Smarty with user login name Smarty 1975 (his nickname and birthday). Bruce has established 4 sender connections:
Government Agency;
Bank;
Postal Administration; and
Payment Provider.

As discussed above, each organisation has a unique SAM established and recorded in member database 24 and sender's CRM system.

The connection to Payment Provider processes payments Bruce makes in communication system 10.

Bruce has used different variations of his name with each organisation, namely: Bruce Smart, Bruce L. Smart, Lee Smart and B. L. Smart. However, from the fact of established connections and the associated identity authentications, it is apparent that each organisation is satisfied with Bruce's identification using the name provided, and it is likely to match the name recorded in the sender's CRM system.

Sender Connections

As discussed above, in order for members 12 to receive communication items, including messages, from senders, a connection must be established. Members 12 can request to be connected to senders listed in service directory 30, and depending on an option chosen by members, connections can be activated using a variety of processes, including online, in person, or over the phone.

The outcome of an activated connection is:
Authority or consent to activate the connection is established; and
Sender has been provided with a SAM for that Member.

Online Connection Process

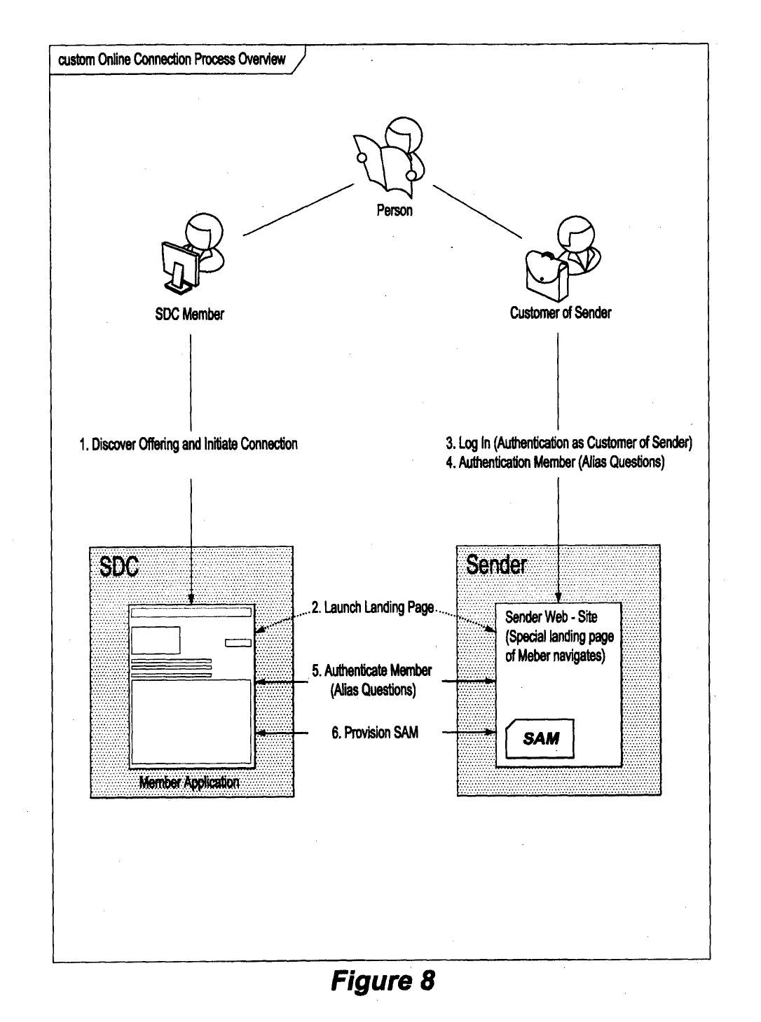

FIG. 8 is a more detailed example of a sender connection workflow required to effect a fully online connection. It will be apparent that the process leverages existing means of online authentication provided by sender 12. Online connections are, from member 14's perspective, the most seamless and expedient option of connecting to senders 12. Significant portions of the connection process are performed by sender 12's website 62 (FIG. 1), to which SDC Server 16 interfaces.

Successful interface between SDC Server 16 and sender website 62 requires senders to implement suitable connection functionality for their registered customers on their customer website and site 62 has back-end integration with SDC server 16.

In-person/Phone Connection Process

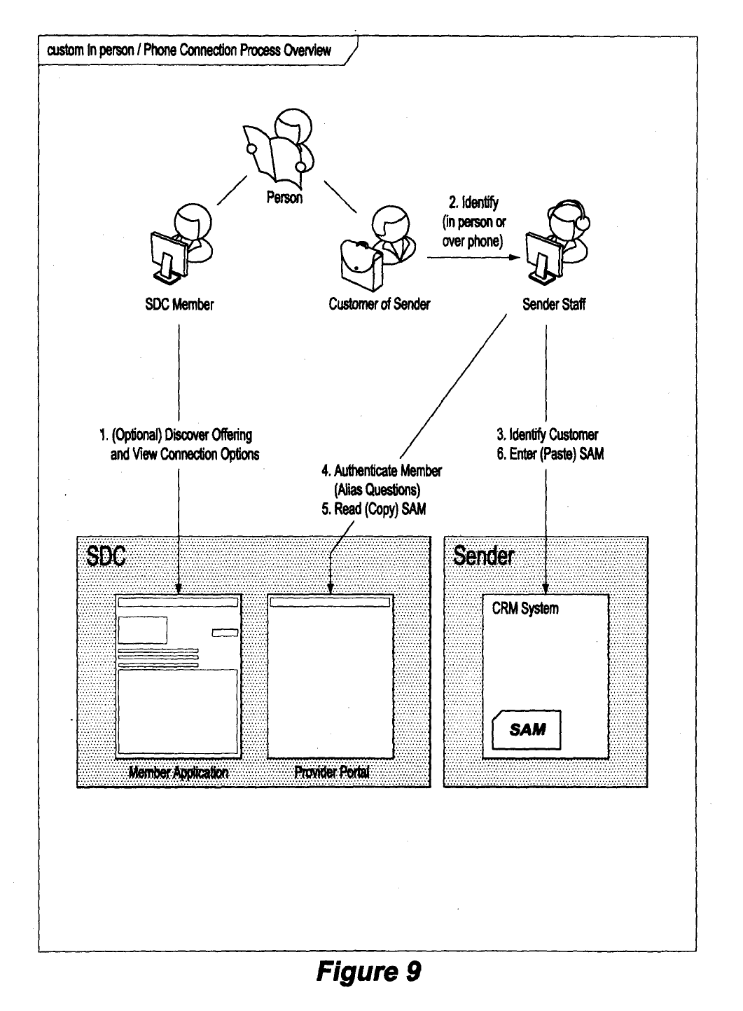

Alternatively, members connect to a senders by visiting their office or making a call to a call centre, as illustrated in FIG. 9.

Connection Process Originated by Campaign

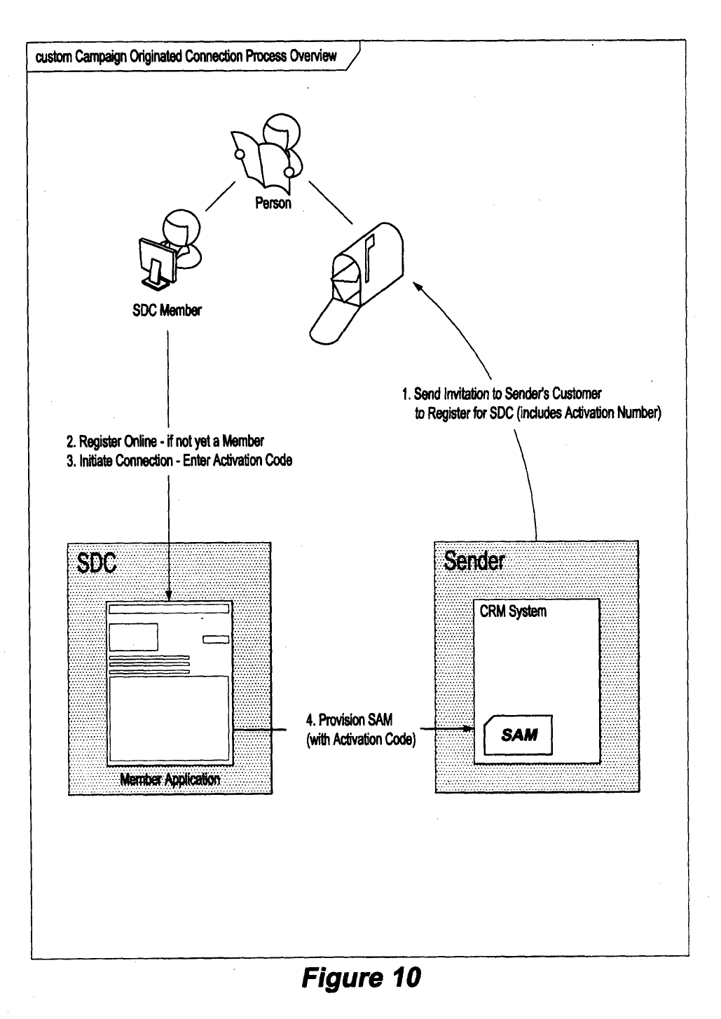

As shown in FIG. 10, connections between members and senders may result from a sender's campaign to prompt its customers to register with communication system 10.

Other Interfaces

As part of sender connection workflow, interfaces are also made with member verification processes of the kind routinely performed in post offices. Typically, this requires exchange of business events, issuing or consumption of physical and digital tokens and generation of outbound notifications.

Similarly, as part of sender connection workflow, interfaces are made with member verification processes of the kind performed in outlets of third party organisations, including sender/provider organisation offices.

In addition, a by-phone connection process is included in sender connection workflow, which leverage existing means of by-phone authentication provided by senders.

Activation Codes

Some connection scenarios necessitate members 14 entering activation codes to complete the connection workflow. Such codes link member sessions with a record in a sender 12's CRM system related to the senders' customer. Activation codes are used to handshake between SDC Server 16 and sender 12 system when SAM is provisioned into the Sender's system.

SAM generation and forwarding

Sam Generator 32 is responsible for generating the SAM codes by which members 14 are known to sender/provider organisation (SAM—Sender's Address to the Member). Typically, SAM's are forwarded from SDC Server 16 to a relevant sender 12's communication system which is responsible for addressing of sender organisations' outbound electronic communications to their customers.

Disconnections

Members de-activate a connection with sender organisations by indicating their intention through member interface 20. Upon receiving a deactivation request SDC Server 16 deletes the SAM allocated to the connection between the member and sender from SAM database 68. The corresponding connection field in the member's account record is also deleted.

Communication Items

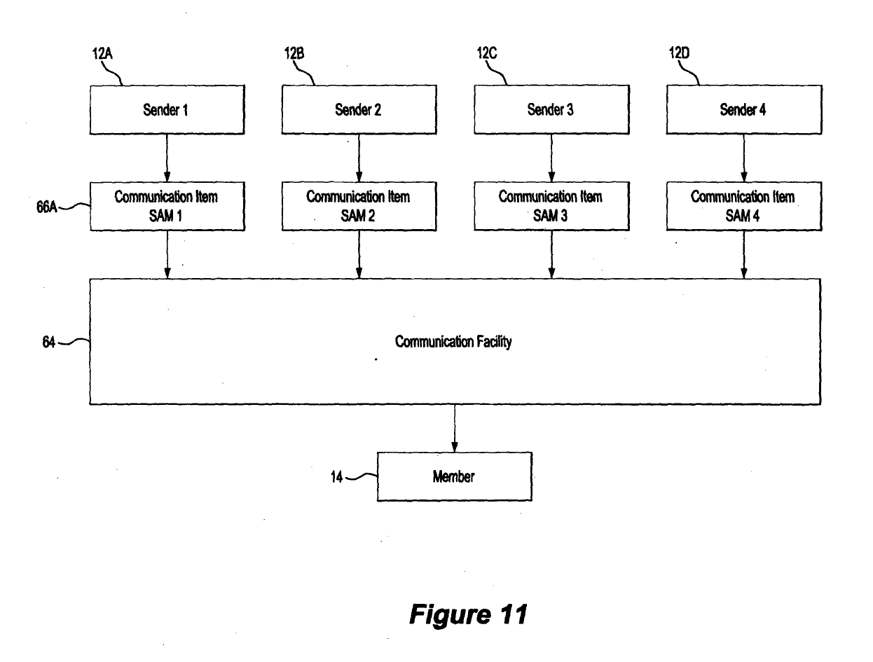

Turning to FIG. 11, a schematic illustration of the process of communication between connected senders 12A-12C and member 14 is shown. Each sender has its own sender address that is included in communication items 66A-66D to member 14. In turn, each communication item 66A-66D is tagged with a SAM as it exits sender 12A-12D's communication system en-route to a communication facility 64 within SDC Server 16. Communication facility 64 is responsible for reading the SAM on each incoming communication item 66 and directing the item to the appropriate member 14.

In the example, a plurality of senders are shown sending communication items, each addressed with a unique SAM, to the one member 14. The SAM scheme (allocating a SAM for each connection) ensures that member 14 has a distinct identity with each sender 12A-12D, and that a member's identity with one sender (for example sender 12A) is not known to other senders.

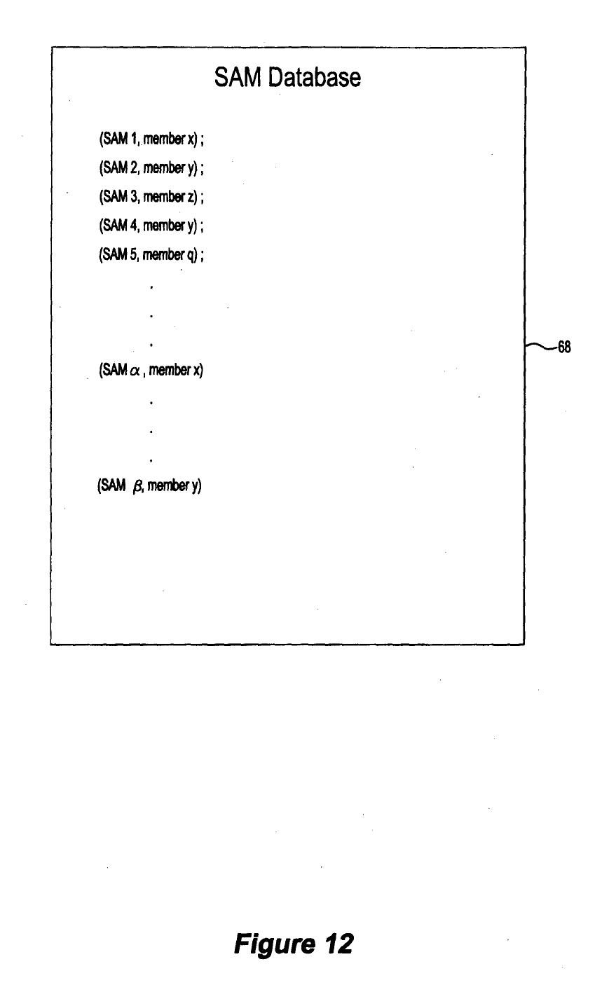

SAMs are stored in a SAM database 68 (FIG. 12), with each SAM having a connection to the member to which it is allocated. As a member may have any number of SAMs, but a SAM can only be allocated to a single member, the relationship of SAM to member is (in a mathematical sense) one of a non-injective function.

Verification of Communication Items

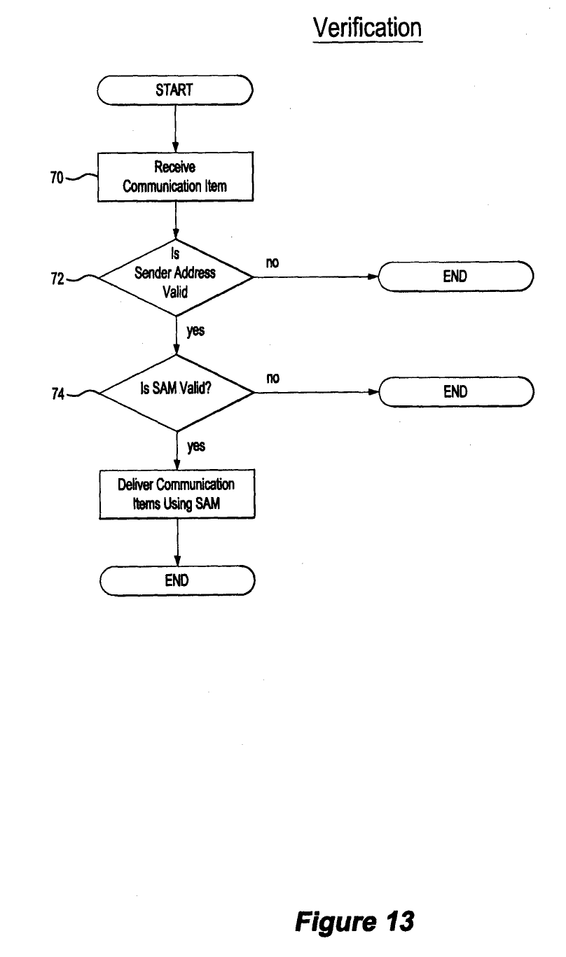

The process of verification of communication items 66 performed by communication facility 64 is described in the flowchart of FIG. 13. At step 70, a communication item (for example 66A) is received at communication facility 64. Communication item 66A includes:
the sender address of the sender 12A from which item 66A originated; and
the SAM that identifies the connection between sender 12A and member 14.

At step 72 communication facility 64 determines whether the sender address is valid. The determination is made by querying sender database 69 to determine whether the sender address is present. Presence of the sender address in sender database 69 signifies that sender has a current registration with communication system 10. In the event that the sender address can not be found in sender database 69, the validation process is terminated, with the result that communication item 66A is not delivered to sender 12A.

Alternatively, in the event that the sender address is valid, the verification process continues to step 74, in which communication facility 64 determines whether the SAM included in communication item 66A is valid. SAM validity is determined by querying SAM database 68 to determine whether the SAM is present. Presence in SAM database 68 indicates that there is a current connection between sender 12A and member 14.

The verification process is terminated in the event that the SAM is not present in SAM database 68, with the result that communication item 66 is not delivered to member 14.

The verification process continues to step 76 in the event that the SAM is determined to be valid, whereupon the communication item 66 is delivered to the member (in this case member 14) for whom the SAM was generated. It is important to note that the verification process for a communication item 66 is complete once the system has confirmed that the sender is valid and the SAM is valid. The verification does not require checking of member details in database 24 or 68, as the very existence of the SAM in the SAM database 68 provides required confirmation of validity of the communication item 66 for the purposes of delivery fulfillment. In other words, the member details are irrelevant for the purposes of verification of communication items.

Communication Items

Communication system 10 enables registered members to perform a series of activities in relation to their communication items. Communication items themselves come in two forms, namely:
actionable communicational items, being communication items that contain a prescribed activity to be undertaken by the member; and
informational communication items, being communication items without a prescribed activity to be undertaken by the member.

The following functions are available within member interface 20 with respect to communication items:
List communication items—list a range of communication items available to a member (latest messages, sorted by sender dates, etc);
View communication item—display a communication item including its main attributes, attachments, meta data, and semantic component in a view which is defined by the ‘type’ of the item, user preference, and application context;
Filter a list of communication items—impose a filter which limits communications items in the list according to a criteria, such as ‘tags’;
Search communication items—perform basic searches to enable fast retrieval of specific communication items using natural language search terms, with or without an additional second stage of filtering to restrict results;
Delete/shred communication item—delete and undelete communication items. Members have to ability to separately choose to shred the communications item, meaning permanent and irrevocable deletion of all form of that CI in member database 24. Depending on the Sender and Document Type, the ability to shred a document may be restricted;
Categorise Communication Item Using Tags—assign a communication item to one or more categories using tags to aid in future retrieval or analysis. Members can add one or more tags, remove tag, edit tag.
Forward CI in e-mail—send an e-mail from communication system 10 with attached or embedded communication item.
Change the status of a message—different actionable messages have a field stating its status (e.g. paid/unpaid). Members have ability to change the status;
Archive communication items—archive their communication items to ‘archive area’;
Initiate contact with sender—a set of features enabling initiation of contact with sender primarily in regards to the communication items. The type of contact and the channel over which it happens may vary;
Override retention period (Configure retention period)—Different document types have default retention periods, with a retention period being determined by a retention policy. Members have ability to overwrite the retention policy for an item or a category of items;
Set/disable a reminder for a communications item
Upload communications item—Members can upload a communication item based on a locally stored file (image, PDF, etc.);
Reclassify communications item—Members can change a type of communication item from an as-received form to one they believe is appropriate. If the change requires meta data or semantic data mandatory for that new CI type, members have to effect a manual data provision. For example, a generic document may need to be reclassified as a utility bill;
Change Item Priority—override the default, system-established priority of a communications item.
Request Hard Copy—generate a request to an approved partner to print and distribute into the mail system a physical copy of the communication item.
Request Off-Line Copy of Data—request one or more DVDs (or alternative storage means) containing encrypted copies of all documents stored in vault 70 in an agreed digital standard such as PDF.

Message Types

A particular species of communication items are known as messages. Messages are of the following types:

Generic Message: similar to a letter and containing text; body; and optionally an attached document.

Message with an Event: Message with semantic structure of type Event.

Payable Message: A message containing a semantic component which conveys mandatory payment details of the message. Payable message structure has:
1. Reference number (such as a bill number, customer number or other unique identifier for customer or the invoice to be paid) for payment;
2. Due date, for when the payment is due to be made.
3. Amount due.

A payable message can be recognised among others by visual attributes visible in a list or in full message view.

Registered Message: A registered message with a confirmation of its receipt by Member. A registered message can be identified among others by visual attributes visible in a list or in full message view.

Acknowledge Registered Message: member is notified in a popup message about any new registered messages received. By clicking on a button Member acknowledges the receipt of a registered message.

Message with a Form: Message containing electronic form, which can be filled by the Member and Returned to Sender.

Message with Appointment Request: Message requesting attendance to an Appointment.

Message with Appointment Confirmation: Message confirming mutual acceptance of an appointment.

Member Interface (General)

Member interface 20 enables members to view targeted content. In addition, members can view various elements of targeted content and easily inform others about communication system 10 using a number of different channels including e-mail and SMS.

Member interface also provides context sensitive help.

Security

Members manage secure access to their own communication items based on ownership of CI and/or by way of appropriate sharing/delegation rules.

Communication items are also protected from internal users and administrators of communication system 10.

Communication system 10 is integrated with various security devices, including key management, data encryption, communications encryption and intrusion prevention

Payments

This package contains payment functionality available in Member Application and Member Agent Application. The package supports online integration of bill payment using Post Bill Pay, without requiring members to be redirected to another Australia Post Online site.

In addition, the package supports online integration with various types of 3rd party payment system (such as PayPal financial services gateway).

The package further supports credit card payment type for bill payments made within communication system 10.

The payment package enables members to schedule a single payment. According to this functionality, a payment screen displays an option to schedule payment for a later date. If member selects to pay on a later date, payment will not be made and an entry is added to the Scheduled payments list until scheduled date. The payment is then made automatically on the scheduled date and the entry removed from the scheduled payments list and added to a transaction list with a receipt number.

The package enables members to view upcoming scheduled payments and to delete scheduled transactions before payment is made. Delete schedule payment functionality displays a transaction list with a delete button/icon for every scheduled payment entry. Upon selection of Delete for any scheduled payment, a confirmation message is displayed to confirm deletion of the scheduled payment with Ok and Cancel buttons. Upon section of Cancel on a confirm delete, the payment entry is suitably not deleted from the list. Upon selection of Ok on Confirm delete, the selected payment entry is suitably removed from the schedule payment list.

In the event of a deletion of selected scheduled payments, navigation to a Pay multiple bills screen, shows those bills in respect of which payment is deleted, in a list of payable bills.

The Payment package enables members to store payment authorisation information with SDC Server 16, to simplify future payments for each supported payment type.

Members can make payments within communication system 10 without necessarily receiving a payable message. For example, member 14 may receive a paper bill and effect payment thereof through communication system 10 using the connected PostBillPay system biller code and reference number (or 3rd party reference code).

The payment package facilitates members to make payments based on received payable message. Payments can also be made for multiple payable messages in a single transaction.

Members can make a payment by supplying all required information at the time of payment (i.e. without relying on a pre-registered payment method). Alternatively, members can make payments using their preferred, registered payment methods.

Finally, payment package provides functionality to reconcile payments made within communication system 10 with external systems, such as accounting software.

Calendar

SDC Server 16 provides an interactive visual tool enabling members to understand the flow of communications, past actions and future reminders from a flexible calendar perspective. This includes viewing information for individual calendar items and linking to any linked communication directly. Access to standard calendar tools such as day/week/month/list views is also provided.

Members can view communication items which are time dependant, such as events or due payments, in a calendar view.

Member can suitably add to calendar items (e.g. events, tasks, reminders) that are not associated with a communication item. In addition, members can establish a link with an external calendar of their choice which is then populated by SDC events.

Member Vault

This package contains functionality related to vault 70 (FIG. 1). The concept of the vault is based on the following principles:
Communication system 10 creates and reinforces the perception of an online service that holds member information securely and privately. This perception is reinforced by a special visual treatment of content held “in the vault” as opposed to content held “not in the vault”.
Vault 70 has more relevance to personal/uploaded content and less relevance to content in official messages.
Vault 70 is both a user interface construct, which may or may not be physically implemented as separate component.

Delegation

Members are provide with rights to access, share and delegate CI items and can delegate access to their account to another person. In consequence, that person (delegatee) can act on behalf of the Member in:
viewing messages/documents
paying payable items using ad-hoc payment method (assuming commitment of delegatee's own funds)
returning forms; and
accepting appointments.

However, delegates are prevented from:
paying payable items using registered payment methods;
connecting or disconnecting from senders;

Senders 12 are informed when access/action by delegation occurs with the connected member.

A delegation may be rescinded, either Delegator or Delegatee, at any time. This remove access to the delegated account from Delegatee.

Member 12 (Delegatee) may not onward delegate an account to which they have received delegated access.

Member can view actions in a delegated account.

Sharing

This module enables sharing of communications between members 12. Conceptually, sharing means providing access to communications and content from one member to another.

Member can share one or more communication items with other member(s). The following communication items may be shared:
Messages stored in SDC Sever 16;
Future messages received in SDC;
Uploaded Documents;

Members can assign permissions for access (read/write/delete) to their communication item by other member at individual CI level or group level. Currently, members may share:
Individual Item
Selected set of items
Items grouped by tag, date range, Sender/Service

In order for sharing to take effect the relevant member must provide an alias of the recipient member. The recipient member receives a sharing notification message and can either accept or reject the proposed sharing.

Either member may rescind the sharing at any time.

Members may not onward share item(s) that to which they have received shared access.

Members can view communications items which are available to them based on rules of sharing. For example, a bill received by one member of a household who is overseas may be shared with other SDC members in the same household.

Some shared communication items can be actioned by a receiving member. Whether, and the extent to which this is allowed, is determined by global business rules, Item metadata, and sharing permissions. Some examples are:
Shared utility bill can be payed(by default);
Certain bills cannot be paid on account of item metadata or sharing permission (however an ad-hoc payment may be allowed);
Forms from certain senders, such as taxation authorities, if shared, cannot be returned (implemented by metadata or a global business rule);

Interaction with Promotional View

Under this module members can express interest in receiving qualified (set by the members) promotions for specific categories. Effective interest periods for receiving promotions can be specified by users and ended at any time.

A list of qualified promotional items available to members according to their expressed interest can be viewed.

Members can view details of a promotional item and can accept a promotion which will be followed up using a sender specific workflow.

Provider Portal

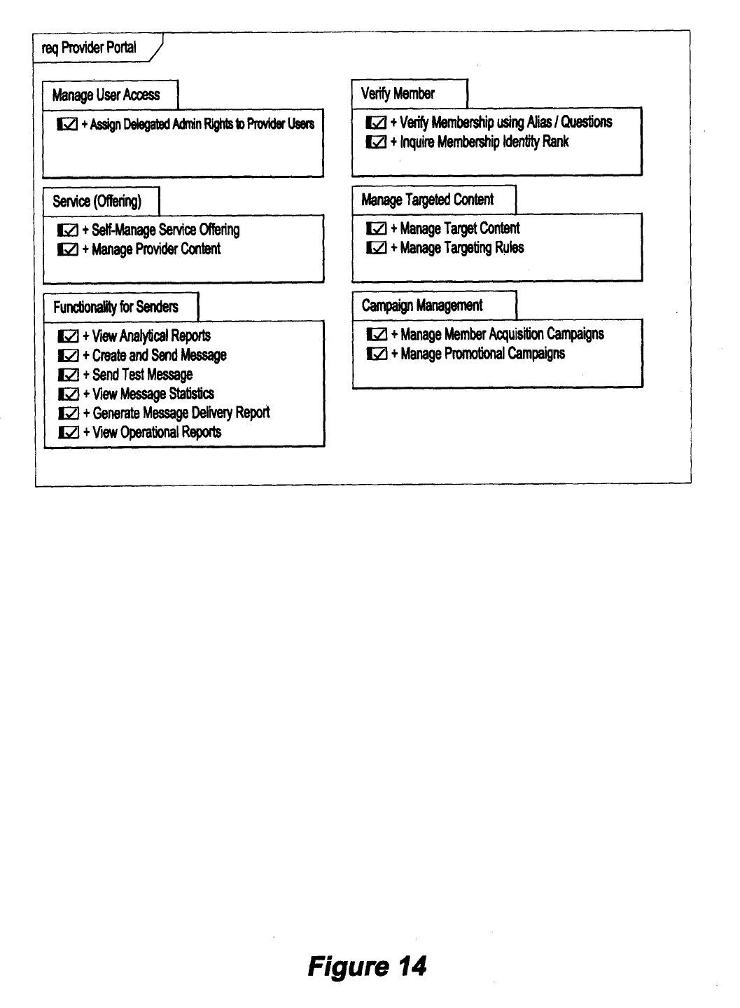

The software modules within provider portal 18 are illustrated in FIG. 14.

Services

Providers are able to establish services (offerings) within SDC Server 16 and advertise these via Service Directory 30. In a typical case, for senders these services can be defined as “deliver SDC messages”. As discussed above, members initiate the establishment of a service relationship by subscribing to the service—this subscription provides the authority or consent as the first part of the process. The Provider (Sender) performs activation of the subscription.

Providers/senders can manage the content which is associated in SDC with their brand.

Sender/provider organisations can also manage their service offerings by:
create new services (offering);
setting an effective period for services; and/or
modify content/business rules associated with services.

Manage User Access

This module manages user access to provider portal 18. Providers can assign granular access rights to the functionality in the portal to provider staff.

Verify Member

This module enables verification of membership using Alias/Questions. A provider can verify an SDC member by using member alias and requiring member to answers security questions. Provider/sender can also request and view a member identity rank.

Functionality for Senders

This package contains the functionality available to senders 12 in provider portal 18.

Analytical reports can be viewed containing aggregate-level information on measurements such as effectiveness of communications and member behaviour.

Senders can create a message using web interface and send it to one or more members.

Senders/Users can select pre-defined test messages to send to one or more members.

Senders can view message statistics, including showing aggregate statistics on communications to members. This includes communication items received and paid.

Message delivery reports can be generated, itemising reports on delivery which can be used to determine the receipt status of every message.

A range of operational reports can be viewed, including reports pertaining to the reach and effectiveness (timeliness) of the sender's communications.

Senders can manage targeted content. This module is complimentary to the messaging channel and provides additional content that is available in Member Application discussed above. Targeted content is addressed to the whole or part of the member population based on demography, geography, preferences and other attributes. Examples of this content are election announcements, government bulletins, news and policy changes. Commercial advertising content can not be delivered through this module, as the module is not based on messaging technology, but instead on personalised content publishing technology.

Senders can manage targeted content in provider portal 18 by defining specific content (information) and addressing it to particular target groups defined by rules.

Targeted content can be managed, including functionality to create, publish and remove targeted messages.

Similarly, targeting rules can be managed, including functionality to create and modify rules that govern delivery of targeted messages.

Campaign Management

Member acquisition campaigns can be managed by senders, including the ability to manage process of acquiring new members from an existing customer base.

The entire lifecycle of a Promotion (Offer) delivered by SDC server can be managed including an ability to capture resulting leads.

The Manage Promotions module includes functionality required for management of Promotions by Providers.

Member Agent Application

This module (FIG. 2) includes a collection of routines for automated actioning of inbound messages based on member rules. The package is responsible for functions performed by communication system 10 on behalf of members.

SDC Severs performs specific actions against inbound messages, when appropriate rules are set by members.

Auto Tagging is generated for inbound messages according to Member's set rules. For example, a statement is received from a bank and is tagged as ‘Tax’. Subsequently received items of similar form are then automatically tagged.

SDC Server 16 enables automated payments of inbound payable messages based on rules previously set by member. Such rules typically include conditions of payment (including Biller, Service, Amount and Time Period).

Notifications for received or due items are delivered thorough ‘out of band’ notifications/reminders of SDC events, such as through SMS or email.

Secure Messaging

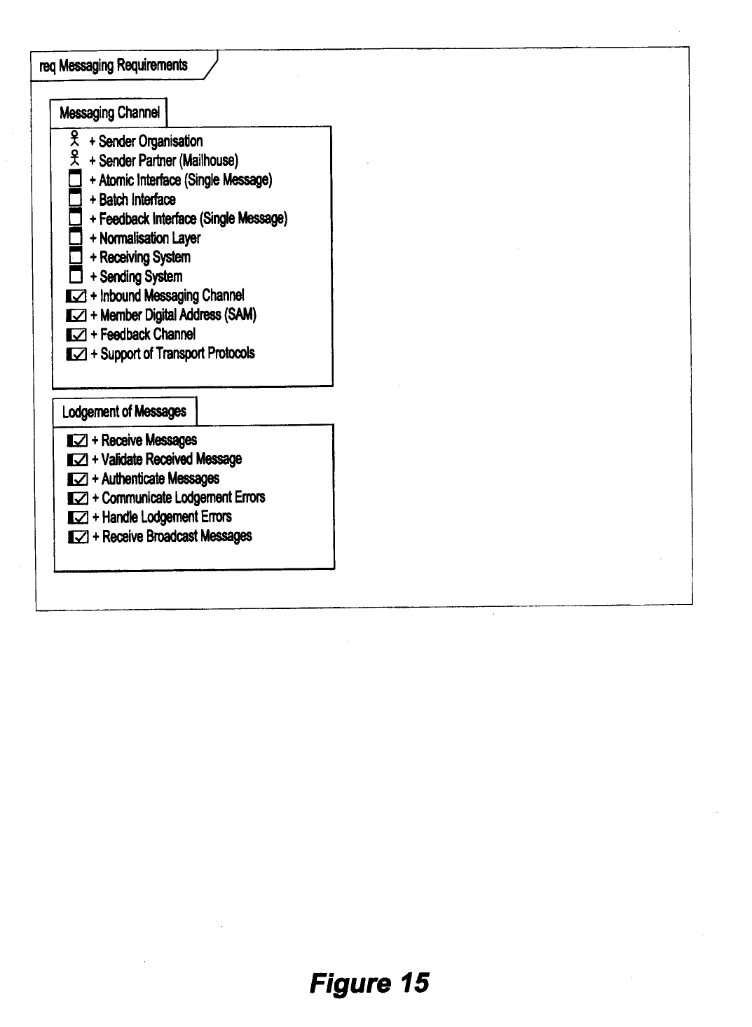

The Secure Messaging Modules are illustrated in FIG. 15.

Lodgement of Messages

The process of receiving messages into SDC Server 16 includes the following steps:
receive message using one of supported transport mechanisms.
authenticate message (i.e verify the message came from a genuine registered sender;
validate message
store message; and
trigger any applicable automated processing

Broadcast Messages

Broadcast messages are those not addressed to individual members but rather sent from a Sender organisation to a large number of Members, as determined by addressing criteria. Only one instance of the message is received, together with addressing criteria. Once the target addresses are determined (the ones that satisfy the criteria) individual copies of the Broadcast message will be created for all the recipients.

Messaging Channel

The Messaging Channel is a sub-module of Secure Messaging and realises delivery of messages from a sender to a member. It includes physical infrastructure, business processes, applications, standards and agreements. The Messaging Channel is:
Digital—delivered electronically to a computer system or mobile device;
Secure—has multiple strong means of protection for Sender, Member and Message; and
Universal—provides common utilitarian function to broad range of public for multiple purposes.

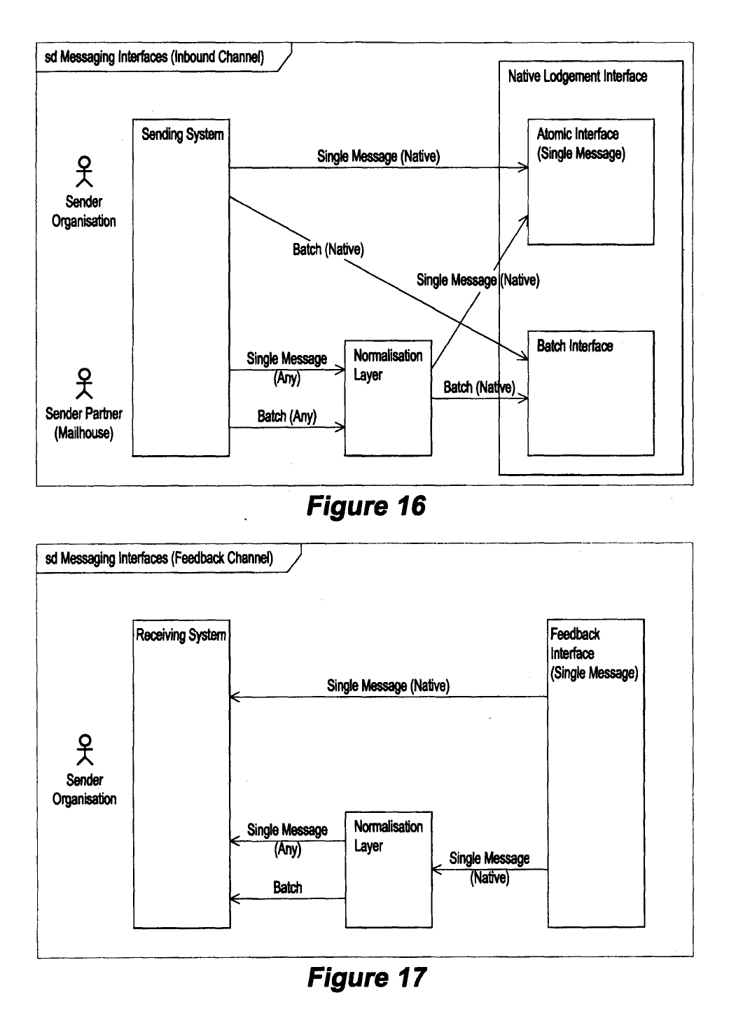

Messaging Interfaces (Inbound Channel) are illustrated in FIG. 16, which provides an overview for required inbound messaging interfaces. Standard “native” SDC interfaces include:
Atomic Interface—accepts single messages; and
Batch Interface—accepts batched messages.

These interfaces assume SDC compliant message formats.

Messaging Interface also includes a Normalisation Layer, which can mediate between a variety of message formats/batch structures and native SDC format. Normalisation level operates at both atomic and batch level.

Senders have two options of connecting to SDC Server 16:
Direct lodgement using native interface (may include their own or third-party transformation capabilities); and
Lodgement to SDC Normalisation Layer.

Messaging Interfaces (Feedback Channel)

FIG. 17 is an overview of the Feedback messaging interfaces. The feedback interface delivers communications from members to senders, usually as a response or comment to a prior message from senders 12 to the members 14.

Standard “native” SDC interface is atomic, in that it sends single messages. If a sender 12 requires a batch interface or different format of messages, batching and transformation capabilities are provided by a normalisation layer as required.

Inbound Messaging Channel

This module is configured to interface with systems that support injection of inbound messages.

SAM Code

As discussed above, communication system 10 facilitates a reliable and secure way of sending messages to the right receiving party. Communication system 10 ensures that messages have been received from a trusted sender and, if so, matches the message with the appropriate member. As discussed above, the message includes, or is tagged with, a SAM code or SAM, which inherently refers to both a sending and receiving party. The SAM is unique for each sender/member combination. It will be appreciated that a sender organisation needs to know the SAM in order to send messages to the communication system, and SDC Server 16 also needs to know the SAM in order to accept (confirm validity of) messages and to then match them to the correct member. However, there is no reason for a member to know or to have access to the SAM, and a SAM would not generally be included with the communication item forwarded to the member.

Feedback Channel

This module supports delivery of messages returned from the member to the sender.

Support of Transport Protocols

SDC messaging channel supports multiple transport protocols including:
FTP,
SMTP,
Web Services,
JMS, and
HTTP.

Whilst communication system 10 supports SMTP Protocol, it does so in a secure manner, such as through a manually populated white list of domain names from which an SMTP server allows messages to be received. The list is gradually compiled over a period of time as sending organisations are connected to the SDC server. The white list prevents unsolicited e-mail messages from being accepted by the SMTP server and appearing in members inboxes in the SDC portal.

Secure SMTP is also used. SSL encrypted sessions only encrypt the SMTP session between the sending organisations machine and the SDC portals servers. The advantage of using this method allows the SDC Server to verify who the sender is based on certificate issued to the organisation.

Virtual Private Networks (VPN) are another supported transport protocol. As known to those skilled in the art, a VPN is a secure a network that is abstracted from the physical network nodes and topology. A VPN creates a private network via a public network (usually the Internet) to connect remote sites or nodes together. Instead of using a dedicated connection such as leased line, a VPN uses “virtual” connections routed through the public network from the sender's corporate network to the SDC Server facilitating the delivering of communication items. Typically, the private network utilises PM infrastructure to establish an encrypted connection between infrastructure nodes that then facilitates the transmission of CI data. The VPN environment can also be used for other media channels such as JMS.

Business Support

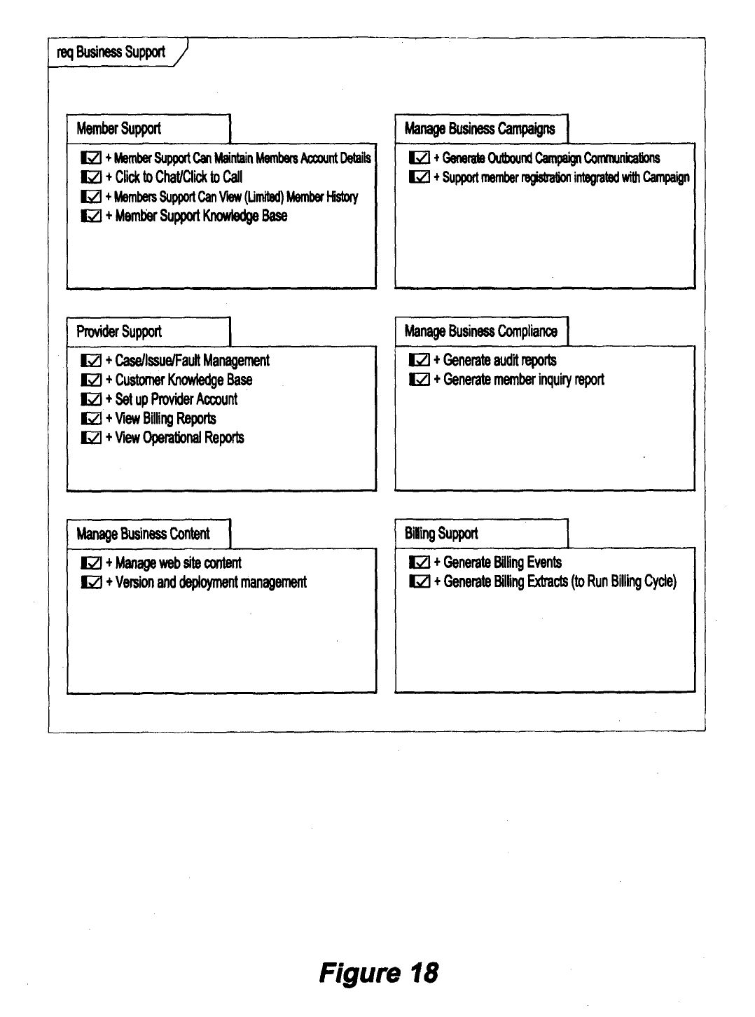

Business Support modules are illustrated in FIG. 18.

The Member Support sub-module is an individual representing a registered sender who is authorised to interact with a potential member or member to answer pre-registration queries, perform authorised account actions and resolve any service queries.

Member support can change account details on behalf of a member.

Members can request service/support via a chat session or a phone call, with calls related to the subject of communications being routed to the corresponding senders customer service line.

Member support can view limited details of a member's history. This provides an ability to view any prior enquiries to member support and key events related to service usage (without impacting privacy)

A Member Support Knowledge Base is provided that member support can access and contribute to a repository of knowledge in relation to common questions and issues.

Provider Support

The provider support sub-module is used by individual representing communication system 10, who are authorised to interact with Sender/Provider Organisation to resolve business/technical issues around the service.

The module enables case/issue/fault management items to be received, classified, responded to and resolved.

A customer knowledge base is provided that is available to all sender staff.

The Set up Provider Account sub-module allows accounts to be created for as yet unregistered organisations, and system and administrative resources allocated for the sender to operate within SDC Sever 16. It includes
Account creation
Account start-up configuration
Account access and administration set up for sender staff members

Billing Reports can be viewed and identified billing issues resolved.

Similarly, operational reports can be viewed in order to monitor quality of customer service and resolve operational issues.

The Manage Business Content sub-module enables management of sender web site content. Any content which is presented to SDC members above and beyond communications and related items, is managed and published using appropriate content management tools and processes.

The sub-module further provides for management of content deployment which involves current and one or more future versions of content and their dates of publishing

The Manage Business Campaigns sub-module includes functionality to generate outbound campaign communications. Communications are generated to drive member acquisition or other campaigns using out of bound means such as email, and physical mail.

Support member registration integrated with campaign module provides accelerated work flows for member registration and sender connection when originated by campaign.

The Manage Business Compliance sub-module generates various types of reports in relation to compliance auditing and member inquiries.

Various audit reports are generated as required for compliance auditing. Reports pertaining to member inquiries are also generated.

The Billing Support sub-module generate billing reports that contains information in relation to each customer's billing cycle and events. In addition, it enables production of billing report(s) as per a specific time frame.

SDC recognise triggers for billing events and generate billing events for further processing in the billing system. Billing events are also reported in an extract which is used to generate a customer bill for a specified period.

Payment Gateway

The package contains routines for interfacing SDC server 16 with a suitable Payment Gateway.

Member Data Encryption

Communication system 10 offers encryption of member data by the following means:
encryption of member messages/documents using common key
encryption of member messages/documents using personal key
encryption of member data “in motion” using channel encryption (e.g. encryption appliances).

Security

In terms of Information Security Classification, the baseline level of protection offered by communication system 10 is consistent with “IN-CONFIDENCE” as defined in the Australian Government Protective Security Manual (PSM) and the Australian Government Information and Communications Technology Security Manual (ISM).

Higher levels of protection (possibly “PROTECTED”) are used for:
service administration/operation,
security enforcement functional areas,
meeting particular Sender requirements for classified information,
aggregation implications.

On a system security classification level, based on the requirement to manage information classified as “IN-CONFIDENCE” and “PROTECTED”, the security design for SDC Server follows guidelines for “PROTECTED” as the default position.

A discussion of some of the terms used in this specification follows. It is to be understood that the purpose of the discussion is to illuminate the concepts that underlie the present invention rather than providing a conclusive definition of terms that are used in the claims.

Benefit A monetary distribution from an Organisation to a Member.

Communication Item An abstraction which represents items of digital communication, both primary (Message, Document) and derived (Reminder, Alert, Transaction). The purpose of the abstraction is to model common presentation and behaviour in Member application.

Connection A process of connecting Members to Senders and an outcome of this process. A Member is connected to a Sender when the Member address (SAM) is known to the Sender and Sender is able to send messages to Member.

Content Item A system abstraction representing a dynamic element of content, text or graphic, presented to Member in Member Application.

Customer An organisation or individual which receives paid services from SDC. All Sender Organisations are Customers (though not necessarily in a one to one relationship, ie. one Customer may have multiple Senders).

Document An item of correspondence which conveys distinct business function, e.g. Notice, Invoice, Receipt, Statement. The system stores documents received in Messages from Senders or uploaded by Members.

Member An individual registered for the SDC service.

Message An item of correspondence sent by Sender to Member.

Messaging Service In Service Directory: a secure digital messaging service offered by a Sender Organisation to Members.

Organisation A general category, which includes Sender and Provider Organisations. An Organisation becomes a Provider by registering its Services/Offerings with SDC. A Provider becomes a Sender after the first Member makes a Connection to the Provider.

Payment A type of Member transaction involving transfer of money.

Promotional Item A special type of content which implements “SDC Promotion” from a Provider to Member. Promotional Item has some special behaviour, including control of Members “viewing” and “accepting” the promotion.

Provider An organisation that provides services to Members and has established services in the Service Directory. Note: Provides include Senders.

Relationship Reflects how a Member relates to an Organisation. Relationships exist when Member is connected to the Sender but also when Member chooses just to use Organisation page to manage information about the Organisation.

Sender An Organisation which is enabled (directly or through a partner) to send messages to Members via SDC.

Service SDC Providers list their Services/Offerings in the Service Directory for Members to subscribe.

Subscription When Member subscribes to a Service from the Directory it results in a Subscription.

Targeted Content Content targeted at particular users by Organisations, which may be static or dynamic.

Transaction A record of important interaction between a Member and an Organisation. Includes but is not limited to Payments.

The word ‘comprising’ and forms of the word ‘comprising’ as used in this description do not limit the invention claimed to exclude any variants or additions.

Modifications and improvements to the invention will be readily apparent to those skilled in the art. Such modifications and improvements are intended to be within the scope of this invention.

It is to be noted that, throughout the description and claims of this specification, the word ‘comprise’ and variations of the word, such as ‘comprising’ and ‘comprises’, is not intended to exclude other variants or additional components, integers or steps.

1. A communication system for facilitating digital communications between senders and members, said system comprising:
a communication server having or associated with:
a member registration facility, configured to enable registration of individuals as members within the communication system;
a sender registration facility, configured to enable registration of organisations as senders within the communication system;
a SAM code generator, configured to generate a SAM code in response to a request from a sender to connect with a member and to forward the SAM code to the sender; and
a communication facility adapted to receive digital communication items including the SAM code and to direct digital communication items to members; and
an address database operatively coupled to the communication server, for storing the generated SAM codes.

2. A communication system according to claim 1, wherein the SAM code generator is configured to generate a SAM code in response to a request from a sender to connect with a member, the sender having verified the member's identity before requesting a SAM code from the communication server.

3. A communication system according to claim 1, wherein the sender registration facility is further configured to issue a unique sender address to organisations upon registration thereof as senders within the communication system, the sender address being included in the sender's digital communication items.

4. A communication system according to claim 3, further including a database of sender records for storing the unique sender addresses.

5. A communication system according to claim 4, wherein the communication facility is adapted to execute a message authentication process upon receipt of communication items at the communication server.

6. A communication system according to claim 5, wherein the message authentication process comprises:
determining whether the sender address of the received communication item is present in the database of sender records; and
determining whether the SAM code in the received communication item is present in the address database.

7. A communication system according to claim 1, further including a connection management module configured to receive requests from members concerning members' connections to senders.

8. A communication system according to claim 7, wherein the connection management module is adapted to receive requests from members to delete the connection to a selected sender, whereupon the SAM code allocated to the selected sender is deleted from the address database.

9. A communication system according to claim 1, further including a secure storage database for secure storage and selective retrieval of members' communication items.

10. A communication system according to claim 1, further including a service directory for storing details of senders' communication service offerings that are available for selection by members.

11. A communication system according to claim 1, further including a member preference module configured to enable members to enter preferences in relation to the member's digital communication items.

12. A communication system according to claim 11, wherein the member preference module is configured to enable members to enter rules that act upon particular digital communication items.

13. A communication system according to claim 11, wherein the member preference module is configured to enable members to designate a communication channel over which particular digital communication items are to be received.

14. A method of facilitating digital communications between senders and members, said method comprising the steps of:
providing a communication system according to claim 1;
receiving and processing requests from organisations and individuals for registration with the communication system;
receiving digital communication items including SAM codes; and
directing digital communication items to members.

15. A method of facilitating digital communication between senders and members, said method comprising the steps of:
providing a communication server having:
a user interface through which individuals can register as members in the communication system; and
a sender interface through which senders can register as senders in the communication system;
receiving a request from a member to connect with a sender;
communicating the request to the sender, whereupon the sender performs an identity verification on the member;
receiving a request for a SAM code from the sender;
generating a SAM code and providing the SAM code to the sender;
storing the SAM code in a database; and
upon receipt of a digital communication item from a sender including a SAM code, determining whether the SAM code is present in the database.

16. A method according to claim 15, further including the step of, if the SAM code is present in the database, sending the digital communication item to the member
